(19) United States
(12) Patent Application Publication
(10) Pub. No.: US 2025/0389087 A1
(43) Pub. Date: Dec. 25, 2025

(54) COMPOSITIONS AND METHODS OF MAKING PAVEMENT AND PAVED SURFACES

(71) Applicant: Board of Regents, The University of Texas System, Austin, TX (US)

(72) Inventors: Sahadat HOSSAIN, Arlington, TX (US); Tanvir IMTIAZ, Arlington, TX (US); Tahsina ISLAM, Arlington, TX (US)

(21) Appl. No.: 19/244,999

(22) Filed: Jun. 20, 2025

Related U.S. Application Data
(60) Provisional application No. 63/662,107, filed on Jun. 20, 2024.

(51) Int. Cl. E01C 7/26; C08L 95/00; E01C 19/02; E01C 19/48

(52) U.S. Cl. CPC E01C 7/26; C08L 95/00; E01C 19/02; E01C 19/48; C08L 2207/20; C08L 2555/86

(57) ABSTRACT

Compositions for pavements and/or paved surfaces and methods of making a paved surface are described. In some embodiments, a composition comprises aggregate in an amount of 50-99 wt. %; bitumen in an amount of 4-8 wt. %; and plastic in an amount of 0.1-4 wt. %, based on the total weight of the asphalt composition; wherein the plastic comprises high density polyethylene (HDPE) and/or polypropylene (PP), or comprises low density polyethylene (LDPE) and PP. In some implementations, the plastic comprises recycled plastic. Additionally, in some embodiments, the plastic comprises high density polyethylene, low density polyethylene, polypropylene, or a combination thereof, and excludes or is essentially free of polystyrene, polyvinylchloride, polyethylene terephthalate, polyacrylate, polyacrylic acid, polycarbonate, and polylactic acid.

### CROSS REFERENCE TO RELATED APPLICATIONS

This application claims priority pursuant to 35 U.S.C. § 119 to U.S. Provisional Patent Application No. 63/662, 107, filed Jun. 20, 2024, which is hereby incorporated by reference in its entirety.

### FIELD

The present invention relates to compositions and methods of making pavement and paved surfaces incorporating plastic, such as for example a road prepared with a composition comprising bitumen, asphalt and plastic, most typically recycled plastic.

### BACKGROUND

The deformation and cracking of flexible pavement is a common problem. The rutting of flexible pavement at elevated temperature is one of the main distresses that commonly occurs in flexible pavement because of the accumulation of the permanent deformation of each layer of the pavement structure under repetitive traffic loading action. Permanent deformation usually occurs because of the consolidation of either the underlying base course because of repeated traffic load along the wheel path or plastic flow near the pavement surface, which significantly reduces both structural and functional performance of the pavement. Fatigue cracking is another means of distress that causes the degradation of pavements. It is caused by repeated traffic loadings, which result in crack initiation, crack propagation, and eventually catastrophic failure of the material because of unstable crack growth. Thus, there exists a need for compositions for pavement or paved surfaces that can perform adequately under a wide range of temperatures, offer resistance against degradation because of stresses and load, have thermal stability, have load spreading capabilities, and have the chemical stability to prevent the pavement from rutting, fatigue, and thermal cracking.

### SUMMARY

In one aspect, compositions for pavement and/or paved surfaces are described herein. In one aspect, an asphalt composition is disclosed comprising: aggregate in an amount of 50-99 wt. %; bitumen in an amount of 4-8 wt. %; and plastic in an amount of 0.1-4 wt. %, based on the total weight of the asphalt composition; wherein the plastic comprises high density polyethylene (HDPE) and/or polypropylene (PP), or the plastic comprises low density polyethylene (LDPE) and PP. In another embodiment, the plastic comprises HDPE, or comprises LDPE and PP. In some embodiments, the composition comprises aggregate in an amount of 90-99 wt. %; bitumen in an amount of 4-5 wt. %; and recycled plastic in an amount of 0.1-2 wt. %, based on the total weight of the asphalt composition. In some embodiments, the plastic is recycled plastic and comprises recycled HDPE and/or recycled PP, or the recycled plastic comprises recycled LDPE and recycled PP. In another embodiment, the recycled plastic comprises recycled HDPE, or comprises recycled LDPE and recycled PP. In some embodiments, the recycled plastic excludes or is essentially free of polystyrene, polyvinylchloride, polyethylene terephthalate, polyacrylate, polyacrylic acid, polycarbonate, and polylactic acid.

In some embodiments, the composition comprises: 0.2-0.8 wt. % recycled HDPE and/or 0.2-0.8 wt. % recycled PP; or the composition comprises 0.2-0.8 wt. % recycled LDPE and 0.2-2 wt. % recycled PP. In some instances, recycled HDPE is coated on the aggregate; in other instances recycled PP is coated on the aggregate; in still other instances recycled LDPE is coated on the aggregate and recycled PP is an aggregate substitute. In some instances, recycled HDPE and recycled PP are both coated on the aggregate.

In one aspect, disclosed herein is a pavement formed from any composition disclosed herein. In some embodiments, the pavement has an air void between 3% and 5%, when measured according to Tex-207 Part I or Tex-227-F; or the pavement has a maximum rutting of less than 7.5 mm, when measured according to AASHTO T 324 or Tex-242-F. In other embodiments, the pavement has an indirect tensile strength between 85 psi and 200 psi, when measured according to ASTM D6931; or the pavement has a tensile strength ratio of greater than or equal to 0.7, when measured according to AASHTO T 283. In still other embodiments, the pavement has a skid resistance greater than 40, when measured according to ASTM D3319.

In one aspect, disclosed herein is a paved surface comprising: a subbase course; a base course; and a surface course, wherein at least one of the subbase course, the base course, and the surface course comprises a recycled plastic, wherein the recycled plastic comprises recycled HDPE and/or recycled PP and/or recycled LDPE. In some embodiments, the plastic comprises recycled LDPE and recycled PP. In some embodiments, recycled HDPE is coated on the aggregate and/or recycled PP is coated on the aggregate. In some embodiments, recycled LDPE is coated on the aggregate and recycled PP is an aggregate substitute and is combined with the LDPE-coated aggregate. In some embodiments, the surface course comprises recycled HDPE and/or recycled PP and/or recycled LDPE. In some embodiments, the surface course comprises recycled HDPE and/or recycled PP, wherein the recycled plastic is coated on the aggregate and/or is used as a replacement for aggregate. In some embodiments, the surface course comprises recycled PP and recycled LDPE, wherein recycled LDPE is coated on the aggregate and PP is a replacement for aggregate. In some embodiments, the base course comprises recycled HDPE and/or recycled PP and/or recycled LDPE. In some embodiments, the base course comprises recycled HDPE and/or recycled PP, wherein the recycled plastic is coated on the aggregate and/or is used as a replacement for aggregate. In some embodiments, the base course comprises recycled LDPE and optionally recycled PP, wherein recycled LDPE is coated on the aggregate and the optional recycled PP is a replacement for aggregate. In some embodiments, the subbase course comprises recycled HDPE and/or recycled PP and/or recycled LDPE. In some embodiments, the subbase course comprises recycled HDPE and/or recycled PP, wherein the recycled plastic is coated on the aggregate and/or is used as a replacement for aggregate. In some embodiments, the subbase course comprises recycled PP and optional recycled LDPE, wherein recycled LDPE is coated on the aggregate and recycled PP is coated on the aggregate and/or is a replacement for aggregate. In some variations of any of the aspects or embodiments disclosed herein, any surface course, subbase course and/or base course can be combined to make a paved road. In some variations of any of the aspects or embodiments disclosed herein, any surface course, subbase course and/or base course comprises a composition comprising aggregate in an amount of 90-99 wt. %; bitumen in an amount of 4-5 wt. %; and recycled plastic in an amount of 0.1-2 wt. %, based on the total weight of the asphalt composition.

In some embodiments, both the subbase course and the surface course comprise a recycled plastic. In some instances, the subbase course comprises recycled LDPE, recycled PP, and/or recycled HDPE. In some embodiments, the surface course comprises recycled HDPE and/or recycled PP, or surface course comprises both recycled LDPE and recycled PP. In some embodiments, (a) the subbase course comprises recycled LDPE, recycled PP, and/or recycled HDPE and (b) the surface course comprises recycled HDPE and/or recycled PP, or surface course comprises both recycled LDPE and recycled PP. In other embodiments the subbase course comprises recycled HDPE coated on the aggregate and/or the surface course comprises recycled HDPE coated on the aggregate. In still other embodiments, the subbase course comprises recycled PP coated on the aggregate and/or the surface course comprises recycled PP coated on the aggregate. In other embodiments the subbase course comprises recycled LDPE coated on the aggregate; and/or the surface course comprises recycled LDPE coated on the aggregate. In some variations of any of the embodiments, PP is an aggregate substitute combined with the LDPE-coated aggregate. In other embodiments, the surface course comprises recycled HDPE coated on the aggregate; and/or recycled PP coated on the aggregate; and/or the surface course comprises recycled LDPE coated on the aggregate and PP is an aggregate substitute combined with the LDPE-coated aggregate. In still other embodiments, the surface course comprises recycled HDPE coated on the aggregate. In other embodiments the surface course comprises recycled PP coated on the aggregate. In other embodiments the surface course surface course comprises recycled LDPE coated on the aggregate and optionally recycled PP combined with the LDPE-coated aggregate.

In one variation of any aspect or embodiment disclosed herein the recycled plastic excludes or is essentially free of one or more of polystyrene, polyvinylchloride, polyethylene terephthalate, polyacrylate, polyacrylic acid, polycarbonate, and polylactic acid. In another variation of any aspect or embodiment disclosed herein the recycled plastic excludes or is essentially free of all of polystyrene, polyvinylchloride, polyethylene terephthalate, polyacrylate, polyacrylic acid, polycarbonate, and polylactic acid.

In one aspect, disclosed herein is a method of making a paved surface, the method comprising: disposing a first composition comprising aggregate, bitumen and recycled plastic as a surface course; and compacting the surface course to form the paved surface, wherein the recycled plastic comprises (i) recycled HDPE, (ii) recycled PP; (iii) recycled HDPE and recycled PP; or (iv) recycled LDPE and recycled PP. In some embodiments, the method further comprises: disposing a second composition on a surface to yield a subbase course; and disposing a third composition on the subbase course to yield a base course; wherein the first composition is disposed on the base course to form the surface course; wherein said second composition comprises aggregate, bitumen and recycled plastic, wherein the recycled plastic comprises recycled LDPE, recycled PP, and/or recycled HDPE; and/or wherein said third composition comprises aggregate, bitumen and recycled plastic, wherein the recycled plastic comprises recycled LDPE, recycled PP, and/or recycled HDPE. In some embodiments, the second and third composition are the same. In some instances, the second and third composition are different.

In one aspect, disclosed herein is a method of preparing a plastic-containing asphalt composition comprising: heating coarse and fine aggregate to at least about 150° C. for at least about an hour; adding a first recycled plastic to the hot aggregate and stirring to yield plastic-coated aggregate; adding bitumen to the plastic-coated aggregate. In some embodiments, the aggregate is heated to at least about 160° C. or to at least about 170° C. The aggregate can be heated for between about 1 and 2 hours, or between about 1.5 and 2.5 hours, or at about 2 hours. In some embodiments, the first recycled plastic comprises recycled HDPE, recycled PP, or recycled LDPE. In some embodiments, the first recycled plastic comprises recycled LDPE and the method further comprises adding recycled PP to the plastic-coated aggregate before bitumen is added.

These and other embodiments are described in more detail in the detailed description which follows.

### BRIEF DESCRIPTION OF THE DRAWINGS

FIG. 1 illustrates a schematic describing the use of recycled plastic in a road, referred herein as a “plastic road” according to one embodiment described herein.

FIG. 2 illustrates a plot of the percentage of aggregate material passing versus sieve size for the surface course layer of pavement according to one embodiment described herein.

FIG. 3A illustrates Combination 1 comprising aggregate, bitumen, and plastics, such as recycled HDPE for plastic road design according to some embodiments described herein.

FIG. 3B illustrates Combination 2, comprising aggregate, bitumen, and plastics, such as recycled PP and recycled LDPE, for plastic road design according to some embodiments described herein.

FIG. 4 illustrates a bar graph of air voids of compositions with different plastic contents according to some embodiments described herein.

FIG. 5 illustrates a control sample (left) and a sample (right) tested using a Hamburger Wheel Track test according to one embodiment described herein.

FIG. 6 illustrates a bar graph of rutting results of compositions with different plastic contents according to some embodiments described herein.

FIG. 7 illustrates an apparatus used to carry out a test method according to ASTM D6931 according to one embodiment described herein.

FIG. 8 illustrates a bar graph of the indirect tensile strength (IDT) in psi of compositions with different plastic contents according to some embodiments described herein.

FIG. 9A illustrates a sample composition frozen according to AASHTO T 283 according to one embodiment described herein.

FIG. 9B illustrates a sample composition thawed according to AASHTO T 283 according to one embodiment described herein.

FIG. 10 illustrates a bar graph of the tensile strength ratio (TSR) of compositions with different plastic contents according to some embodiments described herein.

### DETAILED DESCRIPTION

Embodiments described herein can be understood more readily by reference to the following detailed description and examples. Elements, apparatus, and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, 1 to 4, 3 to 7, 4.7 to 10.0, 3.6 to 7.9, or 5 to 8.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity (that is, the amount is a non-zero amount). For example, a material present in an amount “up to” a specified amount can be present from a detectable (or non-zero) amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

It is also to be understood that the article “a” or “an” refers to “at least one,” unless the context of a particular use requires otherwise.

In one aspect, compositions for pavement and/or paved surfaces are described herein. In some embodiments, a composition described herein comprises aggregate, bitumen, and plastic. In some implementations, the aggregate is present in an amount of 50-99 wt. %, the bitumen is present in an amount of 4-8 wt. %, and the plastic is present in an amount of 0.1-16 wt. %, based on the total weight of the composition. In one aspect, an asphalt composition is disclosed comprising: aggregate in an amount of 50-99 wt. %; bitumen in an amount of 4-8 wt. %; and plastic in an amount of 0.1-4 wt. %, based on the total weight of the asphalt composition; wherein the plastic comprises high density polyethylene (HDPE) and/or polypropylene (PP), or the plastic comprises low density polyethylene (LDPE) and PP. In another embodiment, the plastic comprises HDPE, or comprises LDPE and PP. In some embodiments, the composition comprises aggregate in an amount of 90-99 wt. %; bitumen in an amount of 4-5 wt. %; and recycled plastic in an amount of 0.1-2 wt. %, based on the total weight of the asphalt composition. In some embodiments, the plastic is recycled plastic and comprises recycled HDPE and/or recycled PP, or the recycled plastic comprises recycled LDPE and recycled PP. In another embodiment, the recycled plastic comprises recycled HDPE, or comprises recycled LDPE and recycled PP. In some embodiments, the recycled plastic excludes or is essentially free of polystyrene, polyvinylchloride, polyethylene terephthalate, polyacrylate, polyacrylic acid, polycarbonate, and polylactic acid.

In some embodiments, the composition comprises: 0.2-0.8 wt. % recycled HDPE and/or 0.2-0.8 wt. % recycled PP; or the composition comprises 0.2-0.8 wt. % recycled LDPE and 0.2-2 wt. % recycled PP. In some instances, recycled HDPE is coated on the aggregate; in other instances recycled PP is coated on the aggregate; in still other instances recycled LDPE is coated on the aggregate and recycled PP is an aggregate substitute. In some instances, recycled HDPE and recycled PP are both coated on the aggregate.

In some cases, the plastic of a composition described herein comprises high density polyethylene, low density polyethylene, polypropylene, or a combination thereof. In some embodiments, the plastic comprises only one of high density polyethylene, low density polyethylene, and polypropylene. Further, in some implementations, the plastic excludes or is essentially free of polystyrene, polyvinylchloride, polyethylene terephthalate, polyacrylate, polyacrylic acid, polycarbonate, and polylactic acid. Other plastics may also be excluded from a composition described herein, in some embodiments. Moreover, in some instances, the plastic included or excluded from a composition described herein comprises recycled plastic.

In another aspect, pavement and/or paved surfaces formed from compositions and methods described herein are provided. In some embodiments, such a pavement or paved surface is formed from a composition described hereinabove, such as a composition comprising aggregate, bitumen, and plastic. In some implementations, a pavement or paved surface described herein comprises a subbase course, a base course, and a surface course, wherein at least one of the subbase course, the base course, and the surface course comprises a plastic, such as for example, a recycled plastic. In some such instances, the recycled plastic comprises high density polyethylene, low density polyethylene, polypropylene, or a combination thereof. Moreover, in some cases, the recycled plastic excludes or is essentially free of polystyrene, polyvinylchloride, polyethylene terephthalate, polyacrylate, polyacrylic acid, polycarbonate, and polylactic acid.

In one aspect, disclosed herein is a paved surface comprising: a subbase course; a base course; and a surface course, wherein at least one of the subbase course, the base course, and the surface course comprises a recycled plastic, wherein the recycled plastic comprises recycled HDPE and/or recycled PP and/or recycled LDPE. In some embodiments, the plastic comprises recycled LDPE and recycled PP. In some embodiments, recycled HDPE is coated on the aggregate and/or recycled PP is coated on the aggregate. In some embodiments, recycled LDPE is coated on the aggregate and recycled PP is an aggregate substitute and is combined with the LDPE-coated aggregate. In some embodiments, the surface course comprises recycled HDPE and/or recycled PP and/or recycled LDPE. In some embodiments, the surface course comprises recycled HDPE and/or recycled PP, wherein the recycled plastic is coated on the aggregate and/or is used as a replacement for aggregate. In some embodiments, the surface course comprises recycled PP and recycled LDPE, wherein recycled LDPE is coated on the aggregate and PP is a replacement for aggregate. In some embodiments, the base course comprises recycled HDPE and/or recycled PP and/or recycled LDPE. In some embodiments, the base course comprises recycled HDPE and/or recycled PP, wherein the recycled plastic is coated on the aggregate and/or is used as a replacement for aggregate. In some embodiments, the base course comprises recycled LDPE and optionally recycled PP, wherein recycled LDPE is coated on the aggregate and the optional recycled PP is a replacement for aggregate. In some embodiments, the subbase course comprises recycled HDPE and/or recycled PP and/or recycled LDPE. In some embodiments, the subbase course comprises recycled HDPE and/or recycled PP, wherein the recycled plastic is coated on the aggregate and/or is used as a replacement for aggregate. In some embodiments, the subbase course comprises recycled PP and optional recycled LDPE, wherein recycled LDPE is coated on the aggregate and recycled PP is coated on the aggregate and/or is a replacement for aggregate. In some variations of any of the aspects or embodiments disclosed herein, any surface course, subbase course and/or base course can be combined to make a paved road. In some variations of any of the aspects or embodiments disclosed herein, any surface course, subbase course and/or base course comprises a composition comprising aggregate in an amount of 90-99 wt. %; bitumen in an amount of 4-5 wt. %; and recycled plastic in an amount of 0.1-2 wt. %, based on the total weight of the asphalt composition.

In some embodiments, both the subbase course and the surface course comprise a recycled plastic. In some instances, the subbase course comprises recycled LDPE, recycled PP, and/or recycled HDPE. In some embodiments, the surface course comprises recycled HDPE and/or recycled PP, or surface course comprises both recycled LDPE and recycled PP. In some embodiments, (a) the subbase course comprises recycled LDPE, recycled PP, and/or recycled HDPE and (b) the surface course comprises recycled HDPE and/or recycled PP, or surface course comprises both recycled LDPE and recycled PP. In other embodiments the subbase course comprises recycled HDPE coated on the aggregate and/or the surface course comprises recycled HDPE coated on the aggregate. In still other embodiments, the subbase course comprises recycled PP coated on the aggregate and/or the surface course comprises recycled PP coated on the aggregate. In other embodiments the subbase course comprises recycled LDPE coated on the aggregate; and/or the surface course comprises recycled LDPE coated on the aggregate. In some variations of any of the embodiments, PP is an aggregate substitute combined with the LDPE-coated aggregate. In other embodiments, the surface course comprises recycled HDPE coated on the aggregate; and/or recycled PP coated on the aggregate; and/or the surface course comprises recycled LDPE coated on the aggregate and PP is an aggregate substitute combined with the LDPE-coated aggregate. In still other embodiments, the surface course comprises recycled HDPE coated on the aggregate. In other embodiments the surface course comprises recycled PP coated on the aggregate. In other embodiments the surface course surface course comprises recycled LDPE coated on the aggregate and optionally recycled PP combined with the LDPE-coated aggregate.

Additionally, in some embodiments, a pavement and/or paved surface described herein may exhibit particular properties or structural characteristics. For example, in some cases, a pavement and/or paved surface formed from a composition or method described herein has an air void between 3% and 5%, when measured according to Tex-207 Part I or Tex-227-F. In some embodiments, the pavement and/or paved surface has a maximum rutting of less than 7.5 mm, when measured according to AASHTO T 324 or Tex-242-F. In some implementations, the pavement and/or paved surface has an indirect tensile strength between 85 psi and 200 psi, between 100 and 200 psi, between 150 and 200 psi, or between 100 and 150 psi, when measured according to ASTM D6931. Additionally, in some embodiments, the pavement and/or paved surface has a tensile strength ratio of greater than or equal to 0.7, when measured according to AASHTO T 283. Moreover, in some such embodiments, the pavement and/or paved surface has a tensile strength ratio between 0.7 and 0.9, when measured according to AASHTO T 283. Further, in some cases, the pavement and/or paved surface has a skid resistance greater than 40, when measured according to ASTM D3319. It is also possible, in some instances, for a pavement or paved surface described herein to have a combination of two or more of the foregoing properties. For example, in some implementations, a pavement or paved surface described herein exhibits an air void described herein, a maximum rutting described herein, an indirect tensile strength described herein, a tensile strength ratio described herein, and a skid resistance described herein. In other cases, a pavement or paved surface described herein may exhibit two, three, or four of the foregoing characteristics.

In yet another aspect, methods of making a paved surface and/or pavement are described herein. Any composition described herein may be used to form such a paved surface and/or pavement. In some embodiments, such a method comprises disposing a composition described herein on a surface, and optionally compacting the deposited composition to form the paved surface. It is further to be understood that a composition described herein can be used to form various portions or layers of a paved surface or roadway. For example, in some embodiments, a paved surface described herein forms a surface course. In other cases, the paved surface forms a subbase course. In still other implementations, the paved surface forms a base course.

In one aspect, disclosed herein is a method of preparing a plastic-containing asphalt composition comprising: heating coarse and fine aggregate to at least about 150° C. for at least about an hour; adding a first recycled plastic to the hot aggregate and stirring to yield plastic-coated aggregate; adding bitumen to the plastic-coated aggregate. In some embodiments, the aggregate is heated to at least about 160° C. or to at least about 170° C. The aggregate can be heated for between about 1 and 2 hours, or between about 1.5 and 2.5 hours, or at about 2 hours. In some embodiments, the first recycled plastic comprises recycled HDPE, recycled PP, or recycled LDPE. In some embodiments, the first recycled plastic comprises recycled LDPE and the method further comprises adding recycled PP to the plastic-coated aggregate before bitumen is added.

In some embodiments, a composition described herein comprises aggregate, bitumen, and plastic. Other components may also be included in a composition described herein, in addition to aggregate, bitumen, and plastic. Moreover, the aggregate, bitumen, plastic, and other components may be present in various amounts and have various properties.

For example, the aggregate component of a composition described herein can have any chemical composition and physical characteristics not inconsistent with the technical objectives of the present disclosure. In some embodiments, for instances, the aggregate component comprises crushed stone, gravel, and/or sand. Additionally, aggregate can be present in the composition in any amount not inconsistent with the technical objectives of the present disclosure. In some implementations, the aggregate is present in an amount of 50-99 wt. %, 50-90 wt. %, 50-80 wt. %, 50-70 wt. %, 50-60 wt. %, 60-99 wt. %, 60-90 wt. %, 60-80 wt. %, 60-70 wt. %, 70-99 wt. %, 70-90 wt. %, 70-80 wt. %, 80-99 wt. %, 80-90 wt. %, or 90-99 wt. %, based on the total weight of the composition.

Similarly, the bitumen component of a composition described herein can have any chemical composition and physical characteristics not inconsistent with the technical objectives of the present disclosure. For example, in some cases, the bitumen component is a liquid at 25° C. and 1 atmosphere (atm) of pressure, over the time scale of 1 day or less. In other cases, the bitumen component is solid at 25° C. and 1 atmosphere (atm) of pressure, over the time scale of 1 day or less. In some embodiments, the bitumen component of a composition described herein comprises a liquid asphalt, asphalt binder, or asphalt cement. Moreover, in some instances, the bitumen component of a composition described herein can be a naturally occurring material or a manufactured material, such as a refined residue from distillation of crude oil. Bitumen can be present in the composition in any amount not inconsistent with the technical objectives of the present disclosure. In some cases, the bitumen is present in an amount of 4-8 wt. %, 4-6 wt. %, or 6-8 wt. %, based on the total weight of the composition. In some implementations, the bitumen is present in an amount of 3-10 wt. %, 3-9 wt. %, 3-8 wt. %, 3-7 wt. %, 3-6 wt. %, 3-5 wt. %, 3-4 wt. %, 4-10 wt. %, 4-9 wt. %, 4-8 wt. %, 4-7 wt. %, 4-6 wt. %, 4-5 wt. %, 5-10 wt. %, 5-9 wt. %, 5-8 wt. %, 5-7 wt. %, 5-6 wt. %, 6-10 wt. %, 6-9 wt. %, 6-8 wt. %, 6-7 wt. %, based on the total weight of the composition. In some implementations, the bitumen composition comprises bitumen and plastic, such as recycle plastic, and the bitumen composition is present in an amount of 3-10 wt. %, 3-9 wt. %, 3-8 wt. %, 3-7 wt. %, 3-6 wt. %, 3-5 wt. %, 3-4 wt. %, 4-10 wt. %, 4-9 wt. %, 4-8 wt. %, 4-7 wt. %, 4-6 wt. %, 4-5 wt. %, 5-10 wt. %, 5-9 wt. %, 5-8 wt. %, 5-7 wt. %, 5-6 wt. %, 6-10 wt. %, 6-9 wt. %, 6-8 wt. %, 6-7 wt. %, based on the total weight of the composition.

Any plastic not inconsistent with the technical objectives of the present disclosure may be used in the plastic component of a composition described herein. In some embodiments, the plastic comprises an organic polymeric material such as high density polyethylene (HDPE), low density polyethylene (LDPE), polypropylene (PP), or a combination thereof. In other embodiments, the plastic comprises HDPE or LDPE. When the plastic comprises LDPE, PP can additionally be incorporated. For example, in some implementations, the plastic present in the composition comprises LDPE and PP. In other instances, the plastic comprises a combination of HDPE and PP. In still other embodiments, the plastic component comprises a combination of

LDPE and HDPE, or a combination of HDPE, LDPE, and PP. Further, in some cases, the plastic comprises only one of HDPE or LDPE.

In addition, in some embodiments, the plastic component of a composition described excludes or is essentially free from certain plastics. For example, in some implementations, the plastic component excludes or is essentially free of one or more of polystyrene, polyvinylchloride, polyethylene terephthalate, polyacrylate, polyacrylic acid, polycarbonate, and polylactic acid. In some implementations, the plastic component excludes or is essentially free of each of polystyrene, polyvinylchloride, polyethylene terephthalate, polyacrylate, polyacrylic acid, polycarbonate, and polylactic acid. It is to be understood that a plastic component that is “essentially free of” a specific material includes 5 wt. % or less, 4 wt. % or less, 3 wt. % or less, 2 wt. % or less, 1.5 wt. % or less, 1 wt. % or less, 0.9 wt. % or less, 0.8 wt. % or less, 0.7 wt. % or less, 0.6 wt. % or less, 0.5 wt. % or less, 0.4 wt. % or less, 0.3 wt. % or less, 0.2 wt. % or less, 0.1 wt. % or less, 0.05 wt. % or less, 0.025 wt. % or less, or 0.01 wt. % or less of that specific material, based on the total weight of the plastic component.

Further, in some instances, the plastic component of a composition described herein comprises, consists of, or consists essentially of recycled plastic. For reference purposes herein, recycled plastic comprises any plastic in the 7 categories according to the Society of Plastics Industry RIC codes. RIC 1 is directed to polyethylene terephthalate. RIC 2 is directed to high density polyethylene. RIC 3 is directed to polyvinylchloride. RIC 4 is directed to low density polyethylene. RIC 5 is directed to polypropylene. RIC 6 is directed to polystyrene. RIC 7 is directed to “other” plastics, including bispenol A, polycarbonate, polylactic acid, polyacrylic acid, butadiene, acrylonitrile, polystyrene, fiberglass, and nylon. RIC identification for a material can be conducted using ASTM D7611.

In some cases, the recycled plastic of a composition described herein comprises recycled plastic identified as RIC 1, RIC 2, RIC 3, RIC 4, RIC 5, RIC 6, RIC 7, or any combination thereof. For example, in some implementations, the recycled plastic comprises high density polyethylene (RIC 2), low density polyethylene (RIC 4), polypropylene (RIC 5), or a combination of two or all three of the foregoing. That is, in some embodiments, the recycled plastic may comprise plastic identified as RIC 2, RIC 4, RIC 5, or any combination thereof.

Moreover, in some embodiments of a composition described herein, the recycled plastic comprises only one of high density polyethylene, low density polyethylene, and polypropylene. In other words, in some cases, the recycled plastic comprises only one plastic identified as RIC 2, RIC 4, or RIC 5. In other embodiments, the recycled plastic comprises RIC 2or RIC 4. When the recycled plastic comprises RIC 4, RIC 5 can additionally be incorporated. In other instances, the recycled plastic comprises RIC 2 and RIC 5; alternately the recycled plastic comprises RIC 4 and RIC 2.

Additionally, in some implementations, the recycled plastic excludes or is essentially free of polystyrene, polyvinylchloride, polyethylene terephthalate, polyacrylate, polyacrylic acid, polycarbonate, and polylactic acid. In other words, in some embodiments, the recycled plastic excludes or is essentially free of recycled plastic identified as RIC 1, RIC 3, RIC 6, or RIC 7.

Plastic can be present in a composition described herein in any amount not inconsistent with the technical objectives of the present disclosure. In some implementations, the plastic described herein is present as a substitute for bitumen. In such examples, the plastic substitutes for bitumen in an amount of 1-16 wt. %, based on the total weight of the bitumen composition, defined here as bitumen plus plastic. In some embodiments, the plastic is present in an amount of 1-15 wt. %, 1-14 wt. %, 1-13 wt. %, 1-12 wt. %, 1-11 wt. %, 1-10 wt. %, 1-9 wt. %, 1-8 wt. %, 1-7 wt. %, 1-6 wt. %, 1-5 wt. %, 1-4 wt. %, 1-3 wt. %, 1-2 wt. %, 2-16 wt. %, 2-15 wt. %, 2-14 wt. %, 2-13 wt. %, 2-12 wt. %, 2-11 wt. %, 2-10 wt. %, 2-9 wt. %, 2-8 wt. %, 2-7 wt. %, 2-6 wt. %, 2-5 wt. %, 2-4 wt. %, 2-3 wt. %, 3-16 wt. %, 3-15 wt. %, 3-14 wt. %, 3-13 wt. %, 3-12 wt. %, 3-11 wt. %, 3-10 wt. %, 3-9 wt. %, 3-8 wt. %, 3-7 wt. %, 3-6 wt. %, 3-5 wt. %, 3-4 wt. %, 4-16 wt. %, 4-15 wt. %, 4-14 wt. %, 4-13 wt. %, 4-12 wt. %, 4-11 wt. %, 4-10 wt. %, 4-9 wt. %, 4-8 wt. %, 4-7 wt. %, 4-6 wt. %, 5-16 wt. %, 5-15 wt. %, 5-14 wt. %, 5-13 wt. %, 5-12 wt. %, 5-11 wt. %, 5-10 wt. %, 5-9 wt. %, 5-8 wt. %, 5-7 wt. %, 5-6 wt. %, 6-16 wt. %, 6-15 wt. %, 6-14 wt. %, 6-13 wt. %, 6-12 wt. %, 6-11 wt. %, 6-10 wt. %, 6-9 wt. %, 6-8 wt. %, 6-7 wt. %, 7-16 wt. %, 7-15 wt. %, 7-14 wt. %, 7-13 wt. %, 7-12 wt. %, 7-11 wt. %, 7-10 wt. %, or 7-9 wt. %, based on the total weight of the bitumen composition.

Alternately, the plastic may be used as a substitute for a portion of the aggregate, for example added to the aggregate before or after the aggregate is combined with plastic and with the bitumen. In such an embodiment, the plastic substitutes for the aggregate in an amount of 0.1-6 wt. %, based on the total weight of the aggregate in the aggregate composition, defined here as aggregate plus plastic. In some embodiments, the plastic is present in an amount of 0.1-5 wt. %, 0.1-4 wt. %, 0.1-3 wt. %, 0.1-2 wt. %, 0.1-1 wt. %, 0.1-0.9 wt. %, 0.1-0.8 wt. %, 0.1 -0.7 wt. %, 0.2-6 wt. %, 0.2-5 wt. %, 0.2-4 wt. %, 0.2-3 wt. %, 0.2-2 wt. %, 0.2-1 wt. %, 0.2-0.9 wt. %, 0.2-0.8 wt. %, 0.2-0.7 wt. %, 0.3-6 wt. %, 0.3-5 wt. %, 0.3-4 wt. %, 0.3-3 wt. %, 0.3-2 wt. %, 0.3-1 wt. %, 0.3-0.9 wt. %, 0.3-0.8 wt. %, 0.3-0.7 wt. %, 0.3-0.6 wt. %, 0.3-0.5 wt. %, -0.4-6 wt. %, 0.4-5 wt. %, 0.4-4 wt. %, 0.4-3 wt. %, 0.4-2 wt. %, 0.4-1 wt. %, 0.4-0.9 wt. %, 0.4-0.8 wt. %, 0.4-0.7 wt. %, 0.4-0.6 wt. %, 0.5-6 wt. %, 0.5-5 wt. %, 0.5-4 wt. %, 0.5-3 wt. %, 0.5-2 wt. %, 0.5-1 wt. %, 0.5-0.9 wt. %, 0.5-0.8 wt. %, 0.5-0.7 wt. %, 0.6-6 wt. %, 0.6-5 wt. %, 0.6-4 wt. %, 0.6-3 wt. %, 0.6-2 wt. %, 0.6-1 wt. %, 0.6-0.9 wt. %, 0.6-0.8 wt. %, 0.7-6 wt. %, 0.7-5 wt. %, 0.7-4 wt. %, 0.7-3 wt. %, 0.7-2 wt. %, 0.7-1 wt. %, or 0.7-0.9 wt. %, based on the total weight of the aggregate composition.

In other cases, the amount of the plastic component may be measured as related to the total weight of asphalt composition comprising aggregate, bitumen and plastic. In some such cases, if the total wt. % of (bitumen +plastic) is 5 wt. % and the aggregate is 95 wt. %, the total amount of the plastic present in the asphalt composition is 0.4%, wherein plastic comprises 8% of the total wt. % of (bitumen +plastic). In some such cases, the total amount of plastic present in the asphalt composition is 0.9 wt. % when the plastic comprises 0.4 wt. % as a bitumen substitute (as 8% of the total wt. % of the bitumen composition) and the plastic further comprises an aggregate substitute of 0.5 wt. %. Thus plastic, with respect to the weight of asphalt composition (bitumen +plastic +aggregate), is present in an amount of 0.1-5 wt. %, 0.1-4 wt. %, 0.1-3 wt. %, 0.1-2 wt. %, 0.1-1 wt. %, 0.1-0.9 wt. %, 0.1-0.8 wt. %, 0.1-0.7 wt. %, 0.2-6 wt. %, 0.2-5 wt. %, 0.2-4 wt. %, 0.2-3 wt. %, 0.2-2 wt. %, 0.2-1 wt. %, 0.2-0.9 wt. %, 0.2-0.8 wt. %, 0.2-0.7 wt. %, 0.3-6 wt. %, 0.3-5 wt. %, 0.3-4 wt. %, 0.3-3 wt. %, 0.3-2 wt. %, 0.3-1 wt. %, 0.3-0.9 wt. %, 0.3-0.8 wt. %, 0.3-0.7 wt. %, 0.3-0.6 wt. %, 0.3-0.5 wt. %, 0.4-6 wt. %, 0.4-5 wt. %, 0.4-4 wt. %, 0.4-3 wt. %, 0.4-2 wt. %, 0.4-1 wt. %, 0.4-0.9 wt. %, 0.4-0.8 wt. %, 0.4-0.7 wt. %, 0.4-0.6 wt. %, 0.5-6 wt. %, 0.5-5 wt. %, 0.5-4 wt. %, 0.5-3 wt. %, 0.5-2 wt. %, 0.5-1 wt. %, 0.5-0.9 wt. %, 0.5-0.8 wt. %, 0.5-0.7 wt. %, 0.6-6 wt. %, 0.6-5 wt. %, 0.6-4 wt. %, 0.6-3 wt. %, 0.6-2 wt. %, 0.6-1 wt. %, 0.6-0.9 wt. %, 0.6-0.8 wt. %, 0.7-6 wt. %, 0.7-5 wt. %, 0.7-4 wt. %, 0.7-3 wt. %, 0.7-2 wt. %, 0.7-1 wt. %, 0.7-0.9 wt. %, 0.7-6 wt. %, 0.7-5 wt. %, 0.7-4 wt. %, 0.7-3 wt. %, 0.7-2 wt. %, 0.7-1 wt. %, 0.8-6 wt. %, 0.8-5 wt. %, 0.8-4 wt. %, 0.8-3 wt. %, 0.8-2 wt. %, 0.8-1 wt. %, 0.8-0.9 wt. %, based on the total weight of the asphalt composition. In some instances, the plastic comprises one type of recycled plastic, in some instances, the plastic comprises two types of recycled plastic, as disclosed herein.

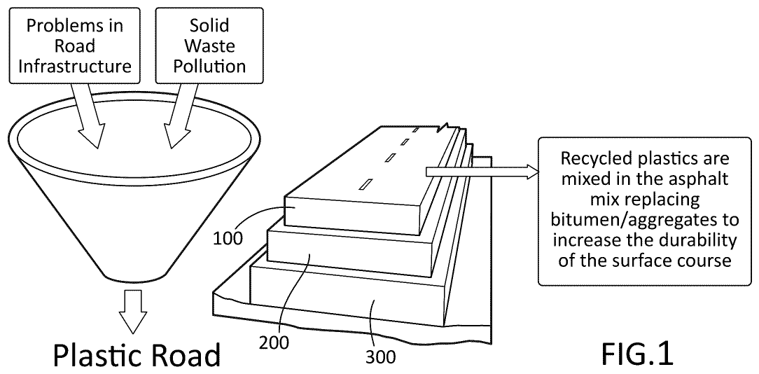

In another aspect, pavement and/or paved surfaces formed from compositions and methods described herein are provided. In some embodiments, such a pavement or paved surface is formed from a composition described hereinabove, such as a composition comprising aggregate, bitumen, and plastic. As represented in FIG. 1, a pavement or paved surface described herein comprises a subbase course, 300, a base course, 200, and a surface course, 100. In some embodiments at least one of the subbase course, the base course, and the surface course comprises a recycled plastic. In this way, the present disclosure addresses challenges in both solid waste pollution and road infrastructure. In some such instances, the recycled plastic comprises high density polyethylene, or a combination of low density polyethylene and polypropylene. Moreover, in some cases, the recycled plastic excludes or is essentially free of polystyrene, polyvinylchloride, polyethylene terephthalate, polyacrylate, polyacrylic acid, polycarbonate, and polylactic acid.

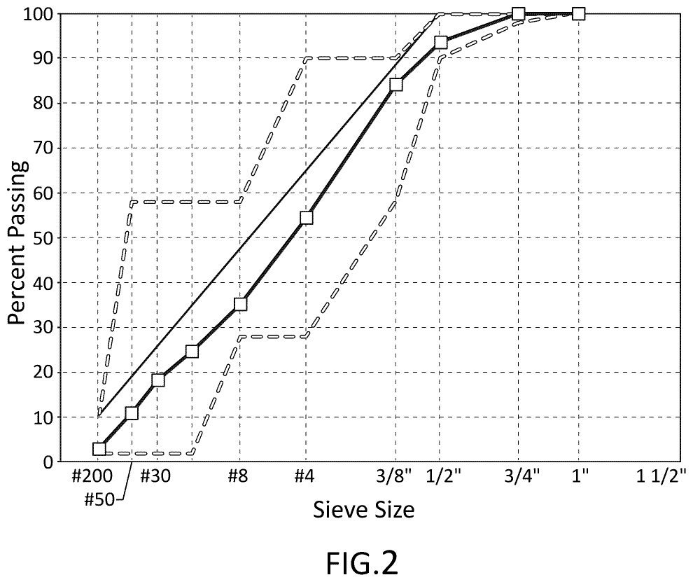

In some embodiments of the present application, HDPE is used in the base course as a replacement for aggregate. Without being bound by theory HDPE is a stiff plastic and when shredded, HDPE has angularity, which increases the strength of aggregate materials in the base. In some embodiments, plastic, specifically recycled plastic, is used both in surface and subbase layers (see FIG. 2).

Additionally, in some embodiments, a pavement and/or paved surface described herein may exhibit particular properties or structural characteristics. For example, in some cases, a pavement and/or paved surface formed from a composition or method described herein has an air void between 3% and 5%, when measured according to Tex-207 Part I or Tex-227-F. In some embodiments, the pavement and/or paved surface has a maximum rutting of less than 7.5 mm, when measured according to AASHTO T 324 or Tex-242-F. In some implementations, the pavement and/or paved surface has an indirect tensile strength between 85 psi and 200 psi, between 100 and 200 psi, between 150 and 200 psi, or between 100 and 150 psi, when measured according to ASTM D6931. Additionally, in some embodiments, the pavement and/or paved surface has a tensile strength ratio of greater than or equal to 0.7, when measured according to AASHTO T 283. Moreover, in some such embodiments, the pavement and/or paved surface has a tensile strength ratio between 0.7 and 0.9, when measured according to AASHTO T 283. Further, in some cases, the pavement and/or paved surface has a skid resistance greater than 40 or greater than 50, when measured according to ASTM D3319, such as a skid resistance between 40 and 70, between 40 and 60, between 40 and 50, between 50 and 70, or between 50 and 60. It is also possible, in some instances, for a pavement or paved surface described herein to have a combination of two or more of the foregoing properties. For example, in some implementations, a pavement or paved surface described herein exhibits an air void described herein, a maximum rutting described herein, an indirect tensile strength described herein, a tensile strength ratio described herein, and a skid resistance described herein. In other cases, a pavement or paved surface described herein may exhibit two, three, or four of the foregoing characteristics.

In yet another aspect, methods of making a paved surface and/or pavement are described herein. Any composition described herein may be used to form such a paved surface and/or pavement. In some embodiments, such a method comprises disposing a composition described herein on a surface, and optionally compacting the deposited composition to form the paved surface. It is further to be understood that a composition described herein can be used to form various portions or layers of a paved surface or roadway. For example, in some embodiments, a paved surface described herein forms a surface course. In other cases, the paved surface forms a subbase course. In still other implementations, the paved surface forms a base course.

Various embodiments of the present technology will now be described in more detail in the following non-limiting Examples.

### EXAMPLES

### Climate Adaptive Roadway Infrastructure Plastic Roads

Climate adaptive, sustainable, resilient infrastructures are necessary for sustainable growth and development. Plastic roads utilize recycled plastic as a partial replacement of bitumen and aggregate for overcoming or minimizing rutting and cracking, and increasing the pavement maintenance period.

Not intending to be bound by theory, it is believed that when bitumen is added to aggregate mixed with plastic, better adhesion occurs between bitumen and plastic-coated aggregate because of strong intermolecular bonding. The viscoelastic property of the mix does not change over time because of the strong intermolecular attraction between bitumen and plastic-coated aggregate, which enhances the durability and stability of pavement. Hence, the plastic road, with prolonged exposure to the atmosphere and in different environmental conditions, does not show any changes in its viscoelastic characteristics. Not intending to be bound by theory, it is believed this helps to increase the stability of the mix and reduces the stripping of bitumen, which results in the raveling and loosening of the surface layers.

Again not intending to be bound by theory, it is believed plastic-containing composite roads, or plastic roads, have better wear resistance than standard asphalt concrete roads. Plastic roads do not absorb water and have better flexibility, resulting in less rutting and therefore less need for repair. Plastic roads are relatively unaffected by corrosion and weather. The plastic road structure, in some cases, can manage temperatures down to −40° F. and up to 176° F. with no negative effects. Since a plastic road can manage excessive seasonal temperature variation, it causes less pavement distress.

Not intending to be bound by theory, it is believed plastic-modified or plastic waste-modified bitumen concrete mixes are more durable, less susceptible to moisture and temperature, and have improved performance in actual field conditions.

Significant advantages of plastic roads are reduced failure risks and maintenance costs of pavement and transportation infrastructure under extreme weather conditions (such as extremely elevated temperature, heavy rainfall, cold and icy conditions). They also help to address climate change (reduction of greenhouse gas emission) by using recycled plastic waste instead of virgin construction materials and convert plastic pollution to a sustainable solution, create a market for recycled plastic, and align with global strategic goals of climate and sustainability through climate change adaptation.

In some instances, the recycled plastic used for plastic roads may be collected from recycling centers or other sources. Moreover, in some cases, one time use plastic bags (mainly LDPE), which are considered as non-recyclables and are widely available in dumpsites, may be used as part of the surface course of a plastic road. Additionally, in some embodiments, HDPE is also utilized as replacement of granular aggregate materials. Thus, in some embodiments, recycled plastic may be used both in surface course and subbase course.

In this non-limiting Example, recycled plastics are mixed in asphalt mix, replacing bitumen or aggregates to increase the durability of the surface course (FIG. 1). The mixes were designed to incorporate recycled plastic in their composition, and the mixes were tested for their characteristics and performance. The compositions described herein provide sustainable compositions with improved durability.

### Mix Design

### Asphalt Binder/Bitumen Selection

Performance Grade (PG) binder according to the climate was selected for the hot-mix asphalt. In selecting a PG binder, a specific binder grade meets all the requirements for that grade and all lesser-performing grades. For example, a PG 64-22 meets the requirements for PG 58-22,PG 58-16, and PG 64-16. Therefore, in the multiple layers, a PG 76-22 might be used for the surface, and a PG 64-22 might be used for all underlying layers to meet design and economic considerations. For a single-layer project, if the climate would typically utilize PG 64-16, a PG 64-22 may be used (theoretically, a better performing grade) with no added binder cost. Other PG binders may be used depending on the project. The properties of the PG binder are tabulated in Table 1.

TABLE 1
Properties of PG Binders.

| | PG 46 | PG52 | PG 58 | PG 64 | PG 70 | PG 76 | PG 82 |
|---|---|---|---|---|---|---|---|
| | Grade range | | | | | | |
| | −34 to | −10 to | −16 to | −10 to | −10 to | −10 to | −10 to |
| | −46 | −46 | −40 | −40 | −40 | −34 | −34 |
| Average 7-day maximum | <46 | <52 | <58 | <64 | <70 | <76 | <82 |
| pavement design | | | | | | | |
| temperature (° C.) | | | | | | | |
| Minimum pavement design | >−34 to | >−10 to | >−16 to | >−10 to | >−10 to | >−10 to | >−10 to |
| temperature (° C.) | >−46 | >−46 | >−40 | >−40 | >−40 | >−34 | >−34 |
| | | Original binder | | | | | |
| Flash-point temperature, D92; | 230 | | | | | | |
| min. (° C.) | | | | | | | |
| Viscosity, D 4402: max. 3 Pa × | 135 | | | | | | |
| s, test temperature (° C.) | | | | | | | |
| Dynamic shear, D7175: | 46 | 52 | 58 | 64 | 70 | 76 | 82 |
| G*/sinδ, min. 1.00 kPa; 25 | | | | | | | |
| mm plate, 1 mm gap; test | | | | | | | |
| temperature at 10 rad/s (° C.) | | | | | | | |

### Aggregate Selection

Table 2 shows upper and lower aggregate gradation limits for the Superpave SP-C surface course material. The distribution of aggregate particles was quantified using a sieve analysis method. Sieve sizes followed standard specifications. For reference purposes herein, the sieve size is defined as the maximum sieve size with no tolerance allowed.

Hydrometer analysis was not required, as less than 1% of the aggregate passed the No. 200 sieve. Superpave SP-C aggregate gradation of 25% Type C rock, 30% Type D rock, 30% Man sand, and 15% recycled asphalt pavement (RAP) was used herein.

TABLE 2
Surface Coarse Aggregate Gradation (% Passing by Weight or Volume).

| | | | | | | | | TxDOT | | Laboratory |
|---|---|---|---|---|---|---|---|---|---|---|
| Sieve Size | | | | Base (Binder)/ | | | | Specification | | Gradation |
| | inch | Base (Binder) | | Surface Course | | Surface Course | | Surface Coarse | | Surface |
| mm | (standard) | Lower | Higher | Lower | Higher | Lower | Higher | Lower | Higher | Course |
| | | Total % passing (by weight) | | | | | | | | |
| 25 | 1 | | 100 | | | | | | 100 | 100 |
| 20 | 0.75 | 90 | 100 | | 100 | | 100 | 95 | 100 | 100 |
| 14 | 0.5 | | | 85 | 100 | 85 | 100 | | | |
| 10 | 0.375 | 55 | 82 | 65 | 90 | 70 | 90 | 70 | 85 | 85 |
| 5 | No. 4 | 35 | 57 | 45 | 65 | 52 | 72 | 43 | 63 | 55 |
| 2.4 | No. 8 | 20 | 40 | 25 | 45 | 40 | 58 | 32 | 44 | 35 |
| 1.2 | No. 16 | 15 | 33 | 15 | 35 | 30 | 48 | | | 25 |
| 0.6 | No. 30 | 10 | 26 | 12 | 30 | 20 | 38 | 14 | 28 | 19 |
| 0.3 | No. 50 | 6 | 20 | 9 | 20 | 14 | 28 | 7 | 21 | 12 |
| 0.15 | No. 100 | 5 | 13 | 5 | 15 | 8 | 20 | | | |
| 0.075 | No. 200 | 3 | 7 | 3 | 7 | 6 | 10 | 2 | 7 | 2 |

Aggregates were selected as per the gradation specifications. Generally, for dense surface course selection, the materials followed the specifications found in Table 1. FIG. 2 shows the aggregate gradation according to the Superpave mix design. The straight line indicates the maximum density line for the aggregate gradation, whereas the dotted lines are the boundaries for the allowable gradation curve for the aggregate sieve analysis.

### Recycled Plastic Selection

To create the mixes, the plastic was directly added to the aggregate. In some samples, 8% plastic by weight of bitumen (bitumen is considered 5% of the total weight of the composition) was used to replace bitumen. HDPE and PP plastics were shredded at size of 0.1-0.25 inches, and LDPE was shredded to a size of 1-2 inches. Other size plastics can be used to achieve the goals identified herein. The percentage of the types of plastics is shown in Table 3.

TABLE 3
Types of Plastics and Their Use in the Asphalt Composition.

| | | Wt. % of | |
|---|---|---|---|
| | | Total | |
| # | Type of Plastic | Composition | Use of Plastic |
| 1 | HDPE | 0.4 | As replacement of bitumen |
| 2 | LDPE | 0.4 | As replacement of bitumen |
| | PP | 0.5 | As replacement of aggregate |

### Plastic Road Mix Design

In plastic road design, for some samples described herein, a percentage of the bitumen was replaced with recycled plastic. In such a substitution, the plastic, such as for example HDPE or LDPE, was mixed with hot aggregate using the dry mix method. Then, bitumen was added to plastic-coated aggregates. In some instances, the dry mix method is helpful because the plastic is coated over stones, improving the surface properties of the aggregates. Moreover, in some cases, the temperature used is the same as the road laying temperature, and no new equipment is required.

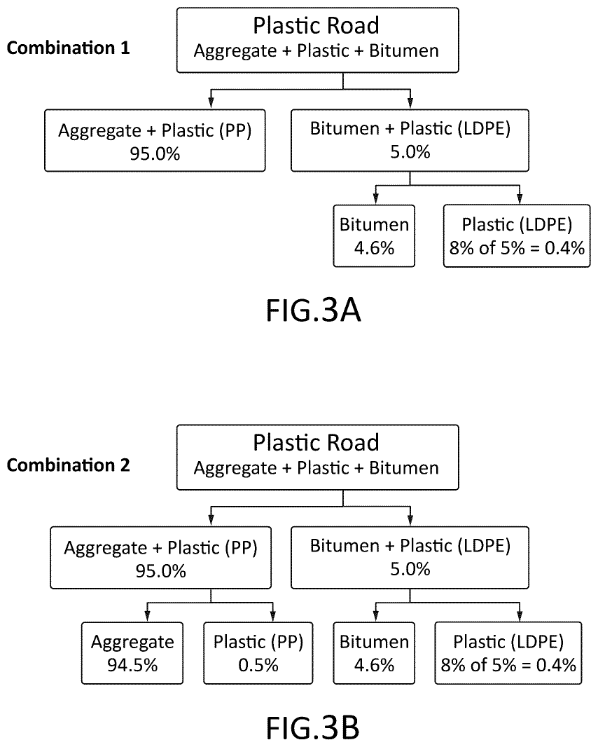

In some non-limiting Examples, the plastic road material, or asphalt composition, comprises: aggregate, plastic, and bitumen. Such a composition is typically used in the surface course of a paved surface. As shown in FIGS. 3A-B, the mixes contained the following percentages by weight of aggregate, plastic, and bitumen: Combination 1: aggregate 95%, bitumen 4.6%, and HDPE 0.4% (8% of total bitumen and plastic). In Combination 2: aggregate 94.5%, 0.5% PP as aggregate, bitumen 4.6%, and LDPE 0.4% (8% of total bitumen +LDPE). Table 4 summarizes the compositions prepared herein.

TABLE 4
Exemplary compositions with respect to wt. % contribution to total
composition (aggregate + bitumen + plastic)

| | | PP | | Plastic |
|---|---|---|---|---|
| | | substitute | | substitute |
| | Aggregate | for aggregate | Bitumen | for bitumen |
| Sample Name | (wt. %) | (wt. %) | (wt. %) | (wt. %) |
| 4% LDPE | 95 | 0 | 4.8 | 0.2 |
| 4% LDPE + | 94.5 | 0.5 | 4.8 | 0.2 |
| 0.5% PP | | | | |
| 4% PP | 95 | 0 | 4.8 | 0.2 |
| 4% HDPE | 95 | 0 | 4.8 | 0.2 |
| 8% LDPE | 95 | 0 | 4.6 | 0.4 |
| 8% LDPE + 0.5% | 94.5 | 0.5 | 4.6 | 0.4 |
| PP (Combination 2) | | | | |
| 8% PP | 95 | 0 | 4.6 | 0.4 |
| 8% HDPE | 95 | 0 | 4.6 | 0.4 |
| (Combination 1) | | | | |

### Mixing Procedure for Preparing Plastic Road Samples

For the mixed samples, the specified amount of coarse and fine aggregate was placed in a pan and retained in an oven at a temperature of 170° C. for 2 hours. Bitumen was kept in the oven at the same time. Preheating was used as the aggregates, plastic, and bitumen were mixed at a heated temperature.

The indicated amounts of shredded plastics were weighed and kept in a separate container. The plastics (HDPE or LDPE) were sprinkled over the hot aggregate, and the plastics and aggregate mixed until the plastic melted and coated the aggregate. When plastic was used as a replacement for aggregate, such as PP in (4% LDPE+0.5% PP) and (8% LDPE +0.5% PP), the plastic was mixed at a temperature of 140° C.-150° C. with the plastic-coated aggregate.

Then, the selected amount of bitumen was added to this mix, and the whole mix was stirred uniformly and homogeneously. This continued for 15-20 minutes until the mixed samples were properly mixed, which was evident from the uniform color throughout the mix. The mixes were kept in the oven for 2 hours at the 150° C. compaction temperature for short-term aging, which simulates asphalt mixture production in a plant. After two hours, samples were prepared using a Superpave Gyratory Compactor (SGC). Table 5 shows the compacting parameters for the Superpave Gyratory Compactor. In some cases, the sample was prepared using a Marshall Compactor. Table 6 shows the compacting parameters for the Marshall Compactor.

TABLE 5
Compacting Parameters for the Superpave Gyratory Compactor.

| Parameter | Value | |
|---|---|---|
| Diameter | 150 | mm |
| Pressure | 600 ± 18 | kPa |
| Angle of gyration | 1.16° ± 0.02° | |
| Number of gyrations | N_{design} = 50 | |
| Speed of rotation | 30 ± 0.5 | gyrations per minute |

TABLE 6
Compacting Parameters for the Marshall Compactor.

| Parameter | Value | |
|---|---|---|
| Diameter of mold | 101.6 mm | (4 in.) |
| Height of mold | 75 mm | (3 in.) |
| Diameter of hammer | 98.4 mm | (3 ⅞ in.) |
| Weight of hammer | 4.5 kg | (10 lb.) |
| Height of Drop | 457 mm | (18 in.) |

### Physical Characteristics and Performance Evaluation

### Density Calculation and Binder Content Selection

Two density tests were used to assess the specified air void for the samples: a bulk specific gravity test (AASHTO T166) and a theoretical maximum specific gravity test or rice gravity test (AASHTO T 209). A minimum of two specimens were prepared for each test, and the average was determined. The properties, including air voids (Vₐ), voids in mineral aggregates (VMA), and voids filled with asphalt (VFA) for asphalt mix without plastics, were calculated, and the asphalt content corresponding to 4% air void was selected. Using 4% air void, the plastic-modified asphalt mix samples were prepared, and these two tests were performed again to determine if the samples conform to the required density and air void presented in Table 7. In Table 7, for reference purposes herein, the dust proportion is defined as % passing #200 sieve divided by the asphalt binder content.

TABLE 7
Minimum Requirement of Volumetric Tests
for Plastic-Modified Bitumen Mixes.

| Property | Requirement |
|---|---|
| Air Void, % | 3-5 |
| G_{mb} (g/cc) | 2.2-2.5 |
| Gₘₘ (g/cc) | 2.4-2.7 |
| VMA (%) | Min 15 |
| VFA (%) | 65-75 |
| Dust Proportion | 0.6-1.6 |

### Performance Tests

The Hamburg Wheel Track Test (HWTT), which is also known as the rutting test (AASHTO T 324), Indirect Tensile Strength Test (AASHTO T 322), Moisture Susceptibility Test AASHTO T 283) and Skid Resistance Test (ASTM D3319) were conducted on the mixed samples (Table 8).

TABLE 8
Performance Tests for Mixed Samples.

| Performance Test | Scope of the Test |
|---|---|
| Hamburg Wheel | To determine the rutting depth due to wheel passes |
| Track Test | in real-time. |
| Indirect Tensile | To determine the cracking resilience of the wheel |
| Strength Test | loads. |
| Moisture | To determine the performance of the asphalt mix |
| Susceptibility Test | due to moisture intrusion. |
| Skid Resistance Test | To determine the slip resistance on the surface of |
| | the pavement. |

The plastic road mix samples fulfilled all the minimum requirement for the properties of performance tests of plastic roads, as shown in Table 9. Samples with any plastics incorporated in the mix design performed better than those without plastic in the laboratory.

TABLE 9
Minimum Requirement for the Performance Test of Plastic Road.

| Property | Requirement |
|---|---|
| Indirect tensile strength, psi | 85-200 |
| Tensile strength ratio (TSR) | Min 0.7 |
| Rutting (Hamburg Wheel Tracker) | Max 12.5 mm @ min 10,000 passes |
| | (for PG 64 or lower) |
| Skid resistance | >30 |

### Air Void Results

The air voids of the plastic road mixes were assessed. Samples were prepared as per specifications, and the air voids were measured using two volumetric tests: bulk density and rice gravity testing according to test methods Tex-207 Part 1 and Tex-227-F, respectively.

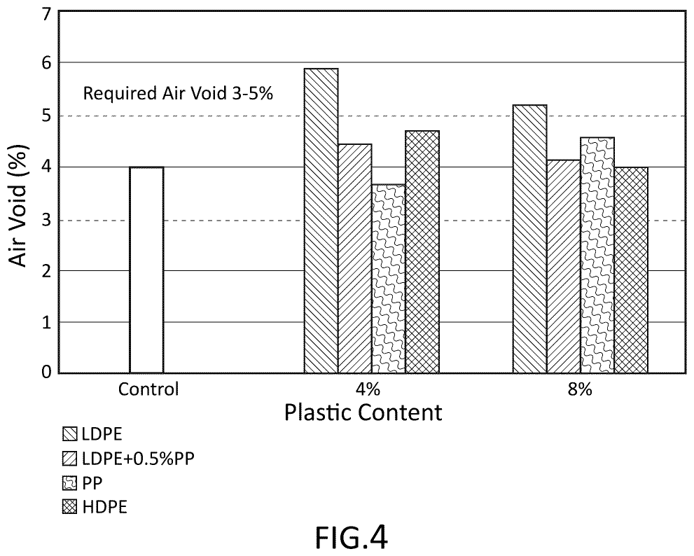

According to the standard, the air voids in the mix should be between 3-5%. The air void analysis result is shown in FIG. 4. FIG. 4 shows that the samples with LDPE did not meet the air void criteria for the standard requirement. To keep the air void within the targeted range, 0.5 wt % PP was mixed as an aggregate replacement while a different percentage of LDPE (0.4 wt % or 0.2 wt %) each relative to the total asphalt composition was used as a bitumen replacement. With an LDPE/PP combination, the air void decreased with an increase in the plastic content up to some percentage, since plastic filled up the internal voids. Furthermore, it was noted that each of PP and HDPE, as the bitumen replacement, met the requirement and maintained the air void measurements in the 3-5% range.

### Hamburg Wheel Track Test (HWTT) Results

The HWTT is often conducted following AASHTO T 324 (Standard Method of Test for Hamburg Wheel-Track Testing of Compacted Hot Mix Asphalt (HMA)) or test method Tex-242-F. This test was performed in submerged conditions at 50° C. This condition was maintained throughout the test to simulate the most vulnerable condition of the asphalt pavement.

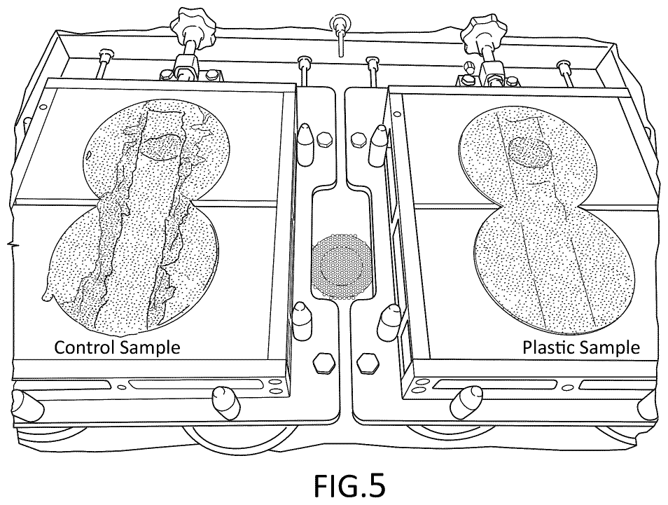

FIG. 5 shows the outcome of the rutting test on the control sample (no plastic was mixed) and the plastic-mixed sample, Combination 1. As shown, the plastic-mixed samples performed significantly well under wheel passes in submerged conditions.

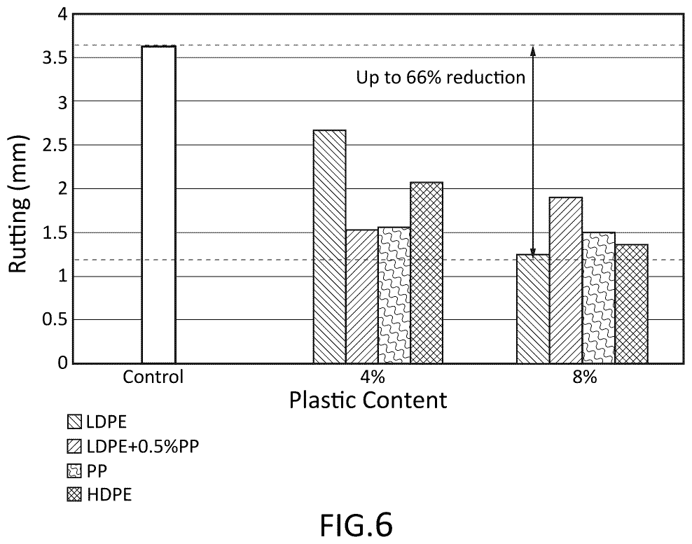

The test results using different plastics in the mixes are shown in FIG. 6. FIG. 6 shows that using LDPE at 8% of the bitumen reduced rut depth by 66%. Not intending to be bound by theory, it is believed too much reduction may make the plastic road rigid. The use of 0.5 wt. % PP as a replacement for aggregate made the asphalt mix more flexible, in part because PP is a flaky, low stiffness material. Using either HDPE or PP in the surface course, reduced the asphalt mixture's deformation significantly.

### Indirect Tensile Strength (IDT) Test Results

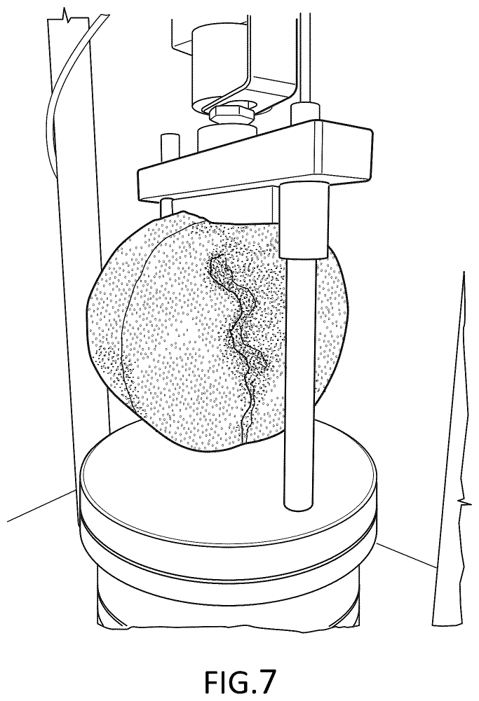

An indirect tensile strength test was conducted by following ASTM D6931. This test method determined the susceptibility of plastic road mixtures to fatigue or reflective cracking (FIG. 7).

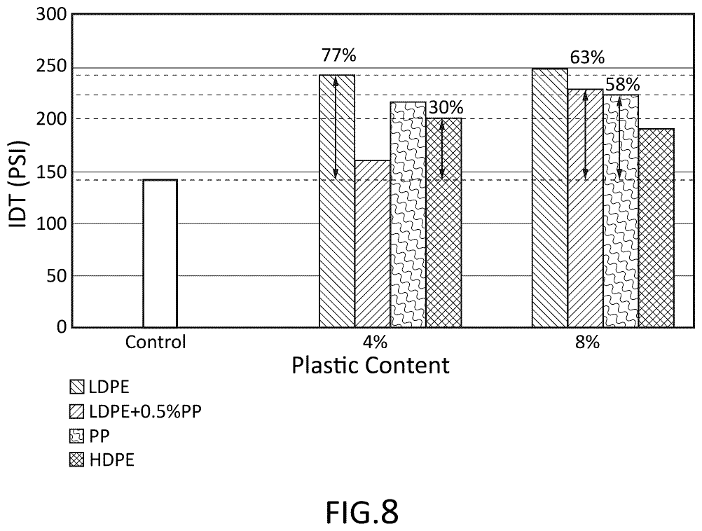

All the plastic mixes have a tensile strength greater than the control mix (FIG. 8). Specifically, adding LDPE and PP in an amount up to 8% of the bitumen increases the tensile strength of the mixture up to 77% and 58%, respectively. Furthermore, adding HDPE at 4% of the bitumen and 8% of the bitumen increases the strength by more than 25%. The rutting test showed promising results with 0.5% PP as aggregate replacement with LDPE in the mix. This combination was utilized to assess the indirect tensile strength. Together by replacing bitumen and aggregate, LDPE and PP can increase the indirect tensile strength by up to 63%.

### Moisture Susceptibility Test

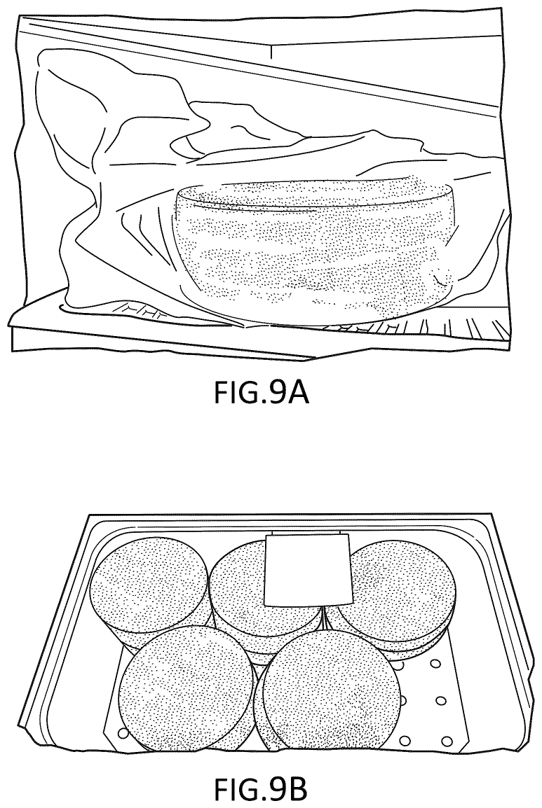

Asphalt pavements are often subjected to extreme weather events such as folding and heavy rainfall. These weather events can cause severe damage to them and so the moisture susceptibility of the plastic road was investigated. For this test, according to AASHTO T 283, the samples were conditioned under a freeze and thaw cycle (as shown in FIG. 9A-B), and after that, the indirect tensile strength test was performed on the samples. The minimum allowable value for TSR is 0.7.

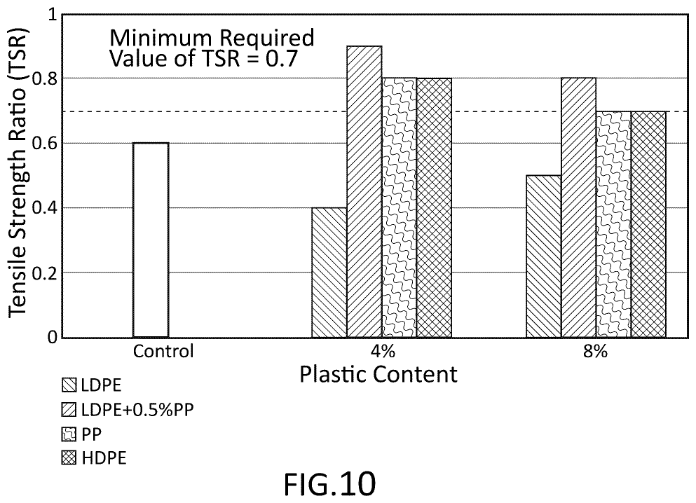

From FIG. 10, it can be observed that LDPE alone in the mix did not fulfill the minimum criteria for the TSR. Not intending to be bound by theory, it is believed that since LDPE is softer and thinner than other types of plastic, it melts quickly, leaving less coating on the aggregate surface and less bonding within the mix. As a result, not intending to be bound by theory, it is believed a significant number of voids remained in the mix, allowing water to percolate, and making the sample susceptible to moisture. To improve the moisture susceptibility, 0.5% by weight of aggregate was replaced by PP. Not intending to be bound by theory, it is believed that this combination of plastics filled the void of the mix and contributed to better bonding between them. Thus, it improved the moisture resistance of the asphalt mixture and showed TSR values between 0.7 to 0.9. Similarly, the PP and HDPE mix had improved moisture susceptibility when used as up to 8% of the total bitumen.

### Additional Tests

In this non-limiting Example, recycled plastics are mixed into asphalt mixes to replace bitumen and/or aggregates to increase the durability. Typically, the plastic-containing asphalt mixes can be used as surface course compositions, but can also be used as base course and/or subbase course compositions. The compositions described herein provide novel and sustainable compositions with improved durability.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. An asphalt composition comprising:
aggregate in an amount of 50-99 wt. %;
bitumen in an amount of 4-8 wt. %; and
plastic in an amount of 0.1-4 wt. %, based on the total weight of the asphalt composition;
wherein the plastic comprises high density polyethylene (HDPE) and/or polypropylene (PP), or comprises low density polyethylene (LDPE) and PP.

2. The composition of claim 1, comprising:
aggregate in an amount of 90-99 wt. %;
bitumen in an amount of 4-5 wt. %; and
recycled plastic in an amount of 0.1-2 wt. %, based on the total weight of the asphalt composition.

3. The composition of claim 2, wherein the recycled plastic excludes or is essentially free of polystyrene, polyvinylchloride, polyethylene terephthalate, polyacrylate, polyacrylic acid, polycarbonate, and polylactic acid.

4. The composition of claim 1, comprising:
(a) 0.2-0.8 wt. % HDPE and/or 0.2-0.8 wt. % PP; or
(b) 0.2-0.8 wt. % LDPE and 0.2-2 wt. % PP.

5. The composition of claim 4, wherein:
(a) HDPE is coated on the aggregate and/or PP is coated on the aggregate; or
(b) LDPE is coated on the aggregate and PP is an aggregate substitute.

6. A pavement formed from the composition of claim 5.

7. The pavement of claim 6, wherein the pavement has an air void between 3% and 5%, when measured according to Tex-207 Part I or Tex-227-F; or the pavement has a maximum rutting of less than 7.5 mm, when measured according to AASHTO T 324 or Tex-242-F.

8. The pavement of claim 6, wherein the pavement has an indirect tensile strength between 85 psi and 200 psi, when measured according to ASTM D6931; or the pavement has a tensile strength ratio of greater than or equal to 0.7, when measured according to AASHTO T 283.

9. The pavement of claim 6, wherein the pavement has a skid resistance greater than 40, when measured according to ASTM D3319.

10. A paved surface comprising:
a subbase course;
a base course; and
a surface course,
wherein at least one of the subbase course, the base course, and the surface course comprises recycled HDPE, and/or recycled PP, or comprises recycled LDPE and recycled PP.

11. The paved surface of claim 10, wherein:
(a) recycled HDPE is coated on the aggregate and/or recycled PP is coated on the aggregate; or
(b) LDPE is coated on the aggregate and PP is combined with the LDPE-coated aggregate.

12. The paved surface of claim 10, wherein both the subbase course and the surface course comprise a recycled plastic.

13. The paved surface of claim 10, wherein:
the subbase course comprises recycled LDPE, recycled PP, or recycled HDPE, and/or the surface course comprises recycled HDPE, recycled PP, or comprises both recycled LDPE and recycled PP.

14. The paved surface of claim 10, wherein:
(a) the subbase course comprises recycled HDPE coated on the aggregate and/or the surface course comprises recycled HDPE coated on the aggregate; and/or
(b) the subbase course comprises recycled PP coated on the aggregate and/or the surface course comprises recycled PP coated on the aggregate; or
(c) the subbase course comprises recycled LDPE coated on the aggregate; and/or the surface course comprises recycled LDPE coated on the aggregate and recycled PP combined with the LDPE-coated aggregate.

15. The paved surface of claim 13, wherein the recycled plastic excludes or is essentially free of polystyrene, polyvinylchloride, polyethylene terephthalate, polyacrylate, polyacrylic acid, polycarbonate, and polylactic acid.

16. A method of making a paved surface, comprising:
disposing a first composition comprising aggregate, bitumen and recycled plastic as a surface course; and
compacting the surface course to form the paved surface, wherein the recycled plastic comprises (i) recycled HDPE, (ii) recycled PP; (iii) recycled HDPE and recycled PP; or (iv) recycled LDPE and recycled PP.

17. The method of claim 16 further comprising:
disposing a second composition on a surface to yield a subbase course; and
disposing a third composition on the subbase course to yield a base course; wherein the first composition is disposed on the base course to form the surface course;
wherein said second composition comprises aggregate, bitumen and recycled plastic, wherein the recycled plastic comprises recycled LDPE, recycled PP and/or recycled HDPE; and/or
wherein said third composition comprises aggregate, bitumen and recycled plastic, wherein the recycled plastic comprises recycled LDPE, recycled PP, and/or recycled HDPE,
wherein the second and third composition are the same or different compositions.

18. A method of preparing a plastic-containing asphalt composition comprising:
heating coarse and fine aggregate to at least about 150° C. for at least about an hour;
adding a first recycled plastic to the hot aggregate and stirring to yield plastic-coated aggregate;
adding bitumen to the plastic-coated aggregate.

19. The method of claim 18, wherein the first recycled plastic comprises recycled HDPE, recycled PP, or recycled LDPE.

20. The method of claim 19, wherein the first recycled plastic comprises recycled LDPE and the method further comprises adding recycled PP to the plastic-coated aggregate before bitumen is added.
